(19) United States
(12) Patent Application Publication
(10) Pub. No.: US 2010/0182075 A1
(43) Pub. Date: Jul. 22, 2010

(54) Power energy supply system with ultracapacitor for vehicle

(76) Inventors: Liang-Ta Yang, Xinzhuang City (TW); Pi-Chu Tseng, Xinzhuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,519

(22) Filed: Jul. 15, 2009

(30) Foreign Application Priority Data
Jan. 16, 2009 (TW) 98101504

(51) Int. Cl. G05F 1/10; H02J 7/00

(52) U.S. Cl. 327/540; 320/166

(57) ABSTRACT

A power energy supply system includes a power generating device, at least one ultracapacitor, and an electronic control module (ECM) for supplying power energy to electric loads coupled to a vehicle circuit system under control of the ECM. The ECM includes a reference voltage value, a voltage-boosting circuit, and a voltage-stabilizing circuit. When the output voltage supplied from the ultracapacitor is smaller than the reference voltage value, the output voltage of the ultracapacitor is boosted by the voltage-boosting circuit and regulated by the voltage-stabilizing circuit before being supplied to the electric loads of the vehicle circuit system. And, when the output voltage from the ultracapacitor is larger than or equal to the reference voltage value, the output voltage of the ultracapacitor is regulated by the voltage-stabilizing circuit before being supplied to the electric loads of the vehicle circuit system.

### FIELD OF THE INVENTION

The present invention relates to a power energy supply system, and more particularly to a power energy supply system with ultracapacitor for vehicle.

### BACKGROUND OF THE INVENTION

Generally, the working power supply internally needed by a car is supplied from a car battery thereof. The car battery is used to start the car engine or to store and supply electric energy. In practical application, the car battery is usually the well-known lead-acid battery.

The lead-acid battery is the oldest type of rechargeable battery and has been widely produced to share a very large part in the global battery market due to many advantages thereof, including simple structure, low price, matured technique, and good cycle life. In the past ten decades, the lead-acid battery is always a standard device for car.

However, the lead-acid battery also has some significant drawbacks, such as non-environmentally friendly, heavy in weight, limited service life, etc. Heavy metals and toxic waste liquid produced in the decomposition of the lead-acid battery would bring serious threats to ecological balance and human health. Moreover, the lead-acid battery includes electrolyte solution containing mercury, lead, cadmium, chrome, nickel, manganese, etc. which will impair the nervous system, hematopoietic cells, kidneys and bones to cause significant hazards to human body.

The lead-acid battery tends to have shortened service life due to frequent high-power pulses. Also, the lead-acid battery has the problem of high self-discharge rate. In the case of deep discharge caused by, for example, constantly turned-on headlights, the lead-acid battery would have further shortened service life and must be replaced with a new one within one or two years. When the lead-acid battery is power low, it will take a long time to recharge the battery because quick charging would usually damage the lead-acid battery.

Further, the lead-acid battery has poor high-current discharge performance. To enable the supply of instant high current, the battery must have increased capacity and accordingly increased weight. Since the increased weight of the battery in turn increases the overall weight of the car, more power must be consumed to drive the car. The lead-acid battery also has poor high-power output performance. As a result, the electric power supplied from the lead-acid battery to the vehicle circuit system tends to have unsteady voltage which will cause unsteady driving and reduced operating efficiency of the car.

### SUMMARY OF THE INVENTION

A primary object of the present invention is to provide a power energy supply system with ultracapacitor for vehicle, so as to overcome the drawbacks of the lead-acid battery particularly in automotive application.

The technique solution adopted by the present invention to overcome the above problems is to provide a power energy supply system with ultracapacitor for vehicle. The power energy supply system includes a power generating device, at least one ultracapacitor, and an electronic control module (ECM). Both the power generating device and the ultracapacitor can supply power via the ECM to the loads. When the power generating device generates electric power, part of the generated electric power is charged to the ultracapacitor via the ECM.

The ECM includes a voltage detection circuit, a control unit, a changeover unit, a reference voltage value, a voltage-boosting circuit, and a voltage-stabilizing circuit. The voltage detection circuit determines an output voltage value of the ultracapacitor. When the output voltage supplied from the ultracapacitor is smaller than the reference voltage value, the ECM controls the changeover unit to switch, so that the output voltage of the ultracapacitor is boosted by the voltage-boosting circuit, regulated by the voltage-stabilizing circuit, and then supplied to the electric loads of the vehicle circuit system. And, when the output voltage from the ultracapacitor is larger than or equal to the reference voltage value, the ECM controls the changeover unit to switch, so that the output voltage of the ultracapacitor is regulated by the voltage-stabilizing circuit and then supplied to the electric loads of the vehicle circuit system.

According to the technical means adopted by the present invention, an ultracapacitor and an electronic control module (ECM) are used to replace the conventional lead-acid battery as a power supply for vehicles. Since the ultracapacitor has electric energy conversion efficiency much higher than that of the conventional lead-acid battery, the ultracapacitor can supply and recycle power energy within a short time at high efficiency. That is, it is able to charge and discharge the ultracapacitor within a very short time. Moreover, unlike the conventional lead-acid battery that is based on chemical reaction, the ultracapacitor stores energy without involving binding or breaking of chemical bonds. Therefore, the ultracapacitor has many advantages, such as long cycle life, wide working temperature range, high energy density, high output power, improved safety, and environmentally friendly.

The materials for forming the ultracapacitor are relatively easily available, and the electrodes of the ultracapacitor are usually made from carbon fibers which are light-weight and compact to largely reduce the weight of the ultracapacitor compared to the conventional lead-acid battery. Therefore, the use of the ultracapacitor in a vehicle circuit system can reduce the power energy needed to drive the vehicle.

Moreover, the combination of the ultracapacitor with the ECM can improve the problems of unsteady voltage and low power output as often found in the existing vehicle circuit systems, enabling a car to drive steadily with comfortableness and increased operating efficiency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of a power energy supply system with ultracapacitor for vehicle according to the present invention; and

FIG. 2 is a fragmentary perspective view showing the power energy supply system with ultracapacitor for vehicle according to the present invention.

### DETAILED DESCRIPTION OF THE PREFERRED EMBODIMENTS

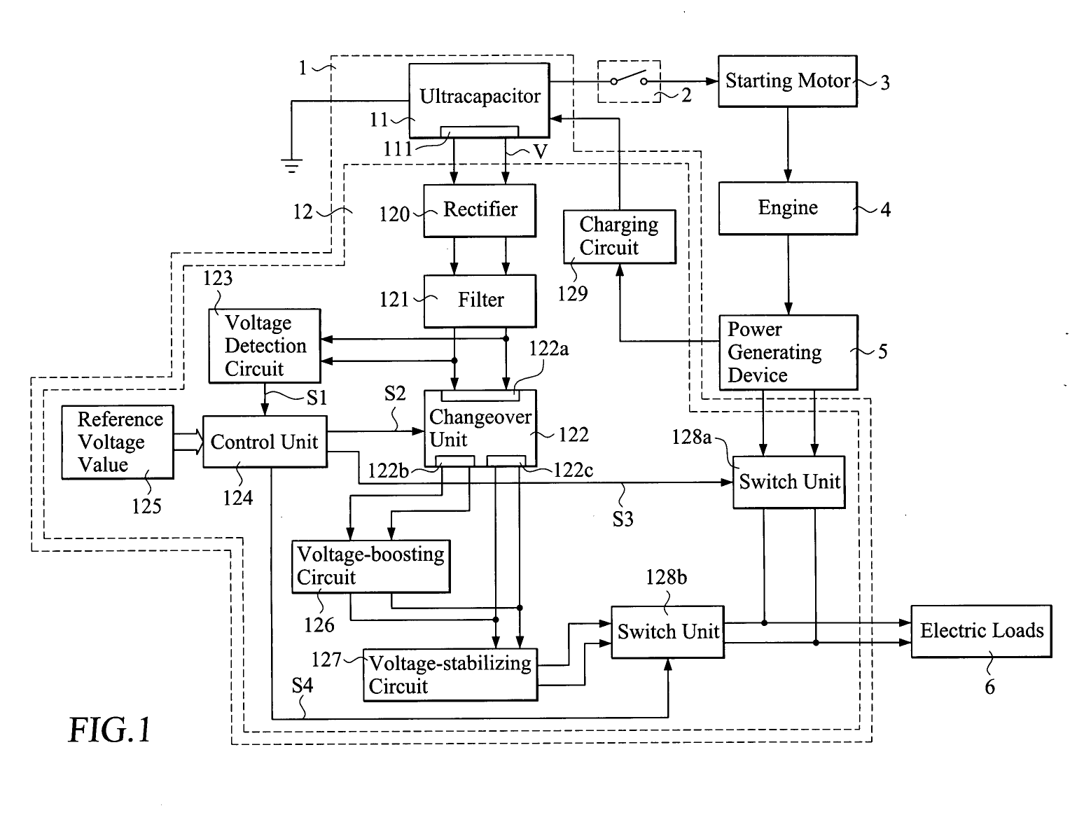

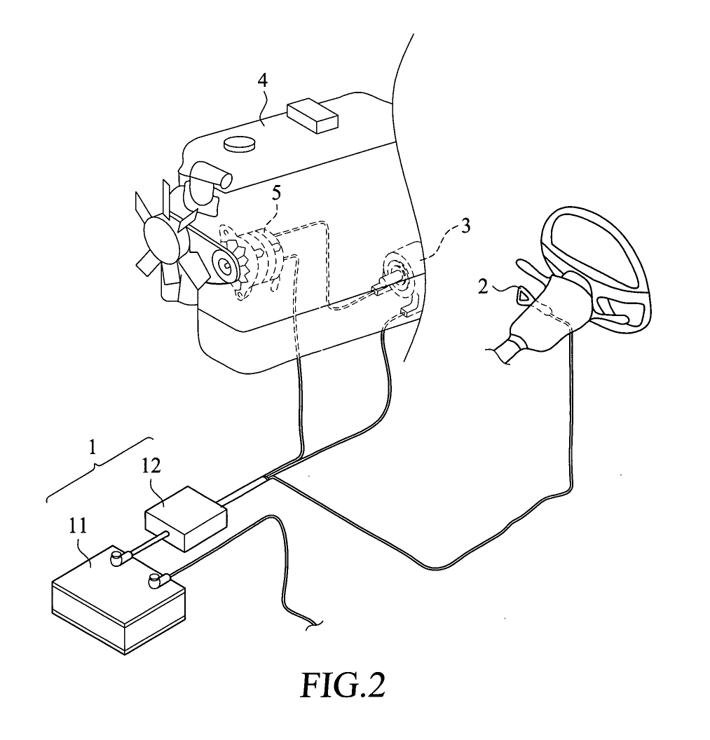

Please refer to FIGS. 1 and 2 at the same time. FIG. 1 is a block diagram of a power energy supply system with ultracapacitor for vehicle according to an embodiment of the present invention; and FIG. 2 is a fragmentary perspective view showing the power energy supply system with ultracapacitor for vehicle according to the present invention. As it is known by one with ordinary skill in the art, a vehicle circuit system generally includes an ignition 2, a starting motor 3, an engine 4, a power generating device 5, and electric loads 6 coupled to the vehicle circuit system.

As can be seen from FIG. 1, the power energy supply system with ultracapacitor for vehicle according to the present invention, which is also briefly referred to as the power energy supply system herein and generally denoted by reference numeral 1, includes a power generating device 5, at least one ultracapacitor 11, and an electronic control module (ECM) 12. When the ignition 2 of the vehicle circuit system is turned on, the at least one ultracapacitor 11 supplies a predetermined starting voltage to the starting motor 3, so as to start the starting motor 3 and bring the engine 4 to operate. When the engine 4 starts operating, the power generating device 5 is simultaneously actuated to generate electric power, which is supplied to the electric loads 6 of the vehicle circuit system via a switch unit 128a of the ECM 12. The ECM 12 includes a charging circuit 129. When the power generating device 5 generates electric power, part of the generated electric power is supplied to charge the ultracapacitor 11 via the charging circuit 129.

On the other hand, when the power generating device 5 stops supplying electric power to the electric loads 6 of the vehicle circuit system, or when the vehicle circuit system consumes a large amount of power energy to result in insufficient power supply from the power generating device 5, the ultracapacitor 11 will supply power energy to the electric loads 6 of the vehicle circuit system under control of the ECM 12.

As shown in FIG. 1, the ECM 12 for the power energy supply system 1 of the present invention includes a rectifier 120, a filter 121, a changeover unit 122, a voltage detection circuit 123, a control unit 124, a voltage-boosting circuit 126, a voltage-stabilizing circuit 127, and two switch units 128a, 128b. When the ultracapacitor 11 supplies power energy, voltage output via a voltage output terminal 111 of the ultracapacitor 11 is rectified by the rectifier 120 and then filtered by the filter 121 to remove the entrained noise. Before being sent to the changeover unit 122, the filtered voltage is first detected by the voltage detection circuit 123 for determining an output voltage value V of the ultracapacitor 11. Meanwhile, a voltage detection signal S1 representing the detected output voltage value V of the ultracapacitor is generated by the voltage detection circuit 123 to the control unit 124.

The control unit 124 receives the voltage detection signal S1 generated by the voltage detection circuit 123, and determines the high/low of the voltage value V of the output voltage of the ultracapacitor 11 by comparing the voltage value V with a reference voltage value 125. When the voltage value V of the output voltage of the ultracapacitor 11 is smaller than the reference voltage value 125, the control unit 124 will send a circuit changeover control signal S2 to the changeover unit 122. In the illustrated embodiment, the changeover unit 122 has a common terminal 122a, a voltage-boosting circuit terminal 122b, and a voltage-stabilizing circuit terminal 122c. The common terminal 122a is electrically coupled to the voltage output terminal 111 of the ultracapacitor 11, the voltage-boosting circuit 126 is connected to the voltage-boosting circuit terminal 122b of the changeover unit 122, and the voltage-stabilizing circuit 127 is connected to the voltage-stabilizing circuit terminal 122c of the changeover unit 122. Based on the received circuit changeover control signal S2, the changeover unit 122 switches the voltage output terminal 111 of the ultracapacitor 11 to connect the same to the voltage-boosting circuit terminal 122b via the common terminal 122a, so that the output voltage of the ultracapacitor 11 is boosted by the voltage-boosting circuit 126 and then regulated by the voltage-stabilizing circuit 127 before being supplied to the electric loads 6 of the vehicle circuit system.

Or, when the voltage value V of the output voltage of the ultracapacitor 11 is equal to the reference voltage value 125, the control unit 124 sends a circuit changeover control signal S2 to the changeover unit 122. Based on the received circuit changeover control signal S2, the changeover unit 122 switches the voltage output terminal 111 of the ultracapacitor 11 to connect the same to the voltage-stabilizing circuit terminal 122c via the common terminal 122a, so that the output voltage of the ultracapacitor 11 is regulated by the voltage-stabilizing circuit 127 before being supplied to the electric loads 6 of the vehicle circuit system.

Further, when the voltage value V of the output voltage of the ultracapacitor 11 is larger than the reference voltage value 125, the control unit 124 sends a circuit changeover control signal S2 to the changeover unit 122. Based on the received circuit changeover control signal S2, the changeover unit 122 switches the voltage output terminal 111 of the ultracapacitor 11 to connect the same to the voltage-stabilizing circuit terminal 122c via the common terminal 122a, so that the output voltage V of the ultracapacitor 11 is regulated by the voltage-stabilizing circuit 127 before being supplied to the electric loads 6 of the vehicle circuit system.

As can be seen from FIG. 1, the switch unit 128a is connected to and between the power generating device 5 and the electric loads 6 of the vehicle circuit system, and the switch unit 128b is connected to and between the voltage-stabilizing circuit 127 and the electric loads 6 of the vehicle circuit system. The control unit 124 controls the switch units 128a, 128b to an on state or an off state. The control unit 124 generates a control signal S3 to the switch unit 128a and another control signal S4 to the switch unit 128b when the power generating device 5 supplies electric power to the electric loads 6 of the vehicle circuit system. At this point, the switch unit 128a receives the control signal S3 and is turned to on, allowing the power generating device 5 to supply electric power to the electric loads 6 of the vehicle circuit system via the switch unit 128a. Meanwhile, the switch unit 128b receives the control signal S4 and is turned to off, preventing the ultracapacitor 11 from supplying power energy to the electric loads 6 of the vehicle circuit system via the switch unit 128b.

Similarly, the control unit 124 generates a control signal S3 to the switch unit 128a and another control signal S4 to the switch unit 128b when the ultracapacitor 11 supplies power energy to the electric loads 6 of the vehicle circuit system. At this point, the switch unit 128a receives the control signal S3 and is turned to off, preventing the power generating device 5 from supplying electric power to the electric loads 6 of the vehicle circuit system via the switch unit 128a. Meanwhile, the switch unit 128b receives the control signal S4 and is turned to on, allowing the ultracapacitor 11 to supply power energy to the electric loads 6 of the vehicle circuit system via the switch unit 128b. In the illustrated embodiment, the switch units 128a, 128b each can further include a rectifier element for limiting electric current direction.

With the above circuit configuration, the power energy supply system 1 according to the present invention combines the power supply and power storage characteristics of the ultracapacitor 11 and the ECM 12 and takes advantage of the merits of the ultracapacitor 11 to enable stable power supply to the electric loads 6 of the vehicle circuit system.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A power energy supply system with ultracapacitor for vehicle, comprising a power generating device, at least one ultracapacitor, and an electronic control module (ECM) for supplying power energy to electric loads coupled to a vehicle circuit system under control of the ECM; the ECM including:
a voltage detection circuit for detecting a voltage value of an output voltage supplied from the ultracapacitor via a voltage output terminal thereof and generating a voltage detection signal representing the output voltage value of the ultracapacitor;
a control unit coupled to the voltage detection circuit for receiving the voltage detection signal generated by the voltage detection circuit and comparing the received voltage detection signal with a reference voltage value to generate a circuit changeover control signal accordingly;
a changeover unit having a common terminal, a voltage-boosting circuit terminal, and a voltage-stabilizing circuit terminal; the common terminal being coupled to the voltage output terminal of the ultracapacitor; the changeover unit receiving the circuit changeover control signal generated by the control unit and switching the voltage output terminal of the ultracapacitor to connect the same to the voltage-boosting circuit terminal or the voltage-stabilizing circuit terminal via the common terminal under control of the received circuit changeover control signal;
a voltage-boosting circuit being connected to the voltage-boosting circuit terminal of the changeover unit; and
a voltage-stabilizing circuit being connected to the voltage-stabilizing circuit terminal of the changeover unit;
wherein when the voltage value of the output voltage supplied from the ultracapacitor is smaller than the reference voltage value, the changeover unit switches the voltage output terminal of the ultracapacitor to the voltage-boosting circuit via the voltage-boosting circuit terminal under control of the received circuit changeover control signal, so that the output voltage of the ultracapacitor is boosted by the voltage-boosting circuit before being supplied to the electric loads of the vehicle circuit system; and wherein when the voltage value of the output voltage supplied from the ultracapacitor is larger than or equal to the reference voltage value, the changeover unit switches the voltage output terminal of the ultracapacitor to the voltage-stabilizing circuit via the voltage-stabilizing circuit terminal under control of the received circuit changeover control signal, so that the output voltage of the ultracapacitor is regulated by the voltage-stabilizing circuit before being supplied to the electric loads of the vehicle circuit system.

2. The power energy supply system as claimed in claim 1, wherein the ECM further includes a rectifier and a filter connected to and between the voltage output terminal of the ultracapacitor and the changeover unit.

3. The power energy supply system as claimed in claim 1, wherein the ECM further comprises a switch unit between the voltage-stabilizing circuit and the electric loads, the switch unit being controlled by the control unit of the ECM.

4. The power energy supply system as claimed in claim 1, wherein the ECM further comprises a switch unit between the power generating device and the electric loads, the switch unit being controlled by the control unit of the ECM.

5. The power energy supply system as claimed in claim 1, wherein the ECM further comprises a charging circuit, through which a part of the electric power generated by the power generating device is supplied to charge the ultracapacitor.

6. The power energy supply system as claimed in claim 1, wherein after boosted by the voltage-boosting circuit, the output voltage of the ultracapacitor is regulated by the voltage-stabilizing circuit and then supplied to the electric loads of the vehicle circuit system.
